(19) United States
(12) Patent Application Publication
(10) Pub. No.: US 2002/0110087 A1
(43) Pub. Date: Aug. 15, 2002

(54) Efficient setup of label-switched connections

(76) Inventors: David Zelig, Givatayim (IL); Yoav Kotser, Givatayim (IL)

Correspondence Address: Michael J. Berger, Amster, Rothstein & Ebenstein, 90 Park Avenue, New York, NY, 10016, US

(21) Appl. No.: 09/935,970

(22) Filed: Aug. 23, 2001

Related U.S. Application Data
(60) Provisional application No. 60/268,760, filed on Feb. 14, 2001.

(51) Int. Cl. H04L 12/56

(52) U.S. Cl. 370/236; 370/401

(57) ABSTRACT

A method for establishing a data link service connection for a bi-directional service to be provided between first and second nodes through a network. Responsive to a request to initiate the service connection, a local index is generated at the first node indicative of the service to be provided, and a first signaling message is sent to the second node containing the index from the first node and service parameters of both of the nodes. Upon receiving the message at the second node, the service connection is initiated responsive to the index and the service parameters. A second signaling message is sent to the first node, and the service indicated by the index is activated.

### CROSS-REFERENCE TO RELATED APPLICATIONS

This application claims the benefit of U.S. Provisional Patent Application No. 60/268,760, filed Feb. 14, 2001, which is incorporated herein by reference.

### FIELD OF THE INVENTION

The present invention relates generally to communication networks, and specifically to methods and systems for establishing data link layer (protocol layer 2) connections over a network using label switching.

### BACKGROUND OF THE INVENTION

Multiprotocol Label Switching (MPLS) is gaining popularity as a method for efficient transportation of data packets over connectionless networks, such as Internet Protocol (IP) networks. MPLS is described in detail by Rosen et al., in Request for Comments (RFC) 3031 of the Internet Engineering Task Force (IETF), entitled “Multiprotocol Label Switching Architecture” (January, 2001), which is incorporated herein by reference. This RFC, as well as other IETF RFCs cited hereinbelow, is available at www.ietf.org/rfc.html. In conventional IP routing, each router along the path of a packet sent through the network analyzes the packet header and independently chooses the next hop for the packet by running a routing algorithm. In MPLS, however, each packet is assigned to a Forwarding Equivalence Class (FEC) when it enters the network, depending on its destination address. The packet receives a short, fixed-length label identifying the FEC to which it belongs. All packets in a given FEC are passed through the network over the same path by label-switching routers (LSRs). Unlike IP routers, LSRs simply use the packet label as an index to a look-up table, which specifies the next hop on the path for each FEC and the label that the LSR should attach to the packet for the next hop.

Since the flow of packets along a label-switched path (LSP) under MPLS is completely specified by the label applied at the ingress node of the path, a LSP can be treated as a tunnel through the network. Such tunnels are particularly useful in network traffic engineering, as well as communication security. MPLS tunnels are established by “binding” a particular label, assigned at the ingress node to the network, to a particular FEC. Multiple tunnels may belong to the same FEC, but each tunnel will have its own label binding. In accordance with the conventions of IP networks, tunnels are necessarily unidirectional. In other words, duplex tunneled communications between a pair of nodes at the edges of a network requires the establishment and binding of two separate, independent tunnels.

MPLS defines a label distribution protocol (LDP) as a set of procedures by which one LSR informs another of the meaning of labels used to forward traffic between and through them. LDPs are needed in order to set up and bind MPLS tunnels. One example of such a protocol is RSVP-TE, which is described by Awduche et al., in an IETF Internet Draft entitled “RSVP-TE: Extensions to RSVP for LSP Tunnels” (February, 2001), which is incorporated herein by reference. This draft is available at search.ietf.org/internet-drafts/draft-ietf-mpls-rsvp-lsptunnel-08.txt. RSVP-TE provides several objects that extend the well-known Resource Reservation Protocol (RSVP), allowing the establishment of explicitly-routed LSPs using RSVP as a signaling protocol. RSVP itself is described by Braden et al., in IETF RFC 2205, entitled “Resource ReSerVation Protocol (RSVP)—Version 1 Functional Specification” (September, 1997), which is incorporated herein by reference. Section 3.10 of RFC 2205 provides for the definition of new objects and object classes to be used in RSVP signaling, such as those provided by RSVP-TE.

RSVP is normally used to set up a data path and allocate network resources for a “session,” which is defined as a data flow with a particular destination and transport-layer protocol. RSVP-TE thus relates to MPLS tunnels as a sort of RSVP session. In order to bind labels to a specific LSP tunnel, the ingress node sends a RSVP Path message, augmented with a LABEL_REQUEST object defined by RSVP-TE, through the network to the egress node. Labels are allocated downstream and distributed (propagated upstream) by means of RSVP Resv messages, which are extended by RSVP-TE with a LABEL object. The above-mentioned RSVP-TE draft describes procedures for label allocation, distribution, binding and stacking using these objects.

When IP packets are passed through a MPLS tunnel, the routing label is removed at the egress node, which then simply routes the packet over its next hop using the packet's IP header. There is no need for the label to tell the egress node what to do with the packet, since the existing IP header, which was applied to the packet before it entered the tunnel, provides all of the necessary information. When layer 2 packets, such as Ethernet frames or ATM cells, are sent through a MPLS tunnel, however, the standard layer 2 media access control (MAC) header that brought the packet to the ingress node does not contain all the information that the egress node requires for delivering the packet to its destination. There is thus a need for a label that tells the egress node how to treat the received packet. If the packet contains an Ethernet frame, for example, the egress node should be able to infer from this label the outgoing interface information, preferably including the optional VLAN (Virtual Local Area Network) identifier, as is known in the Ethernet art.

In response to this problem, Martini et al. have proposed to add a “virtual connection” label (or VC label) to the stack of labels used in transporting layer 2 packets through MPLS tunnels. This proposal is described in detail in an IETF draft entitled “Encapsulation Methods for Transport of Layer 2 Frames over MPLS” (May, 2001), which is incorporated herein by reference. This document is available at search.ietf.org/internet-drafts/draft-martini-12circuitencap-mpls-02.txt. The same authors also specify label distribution procedures for binding the VC label to the desired tunnel in a further draft entitled “Transport of Layer 2 Frames over MPLS” (May, 2001), which is likewise incorporated herein by reference. This latter document is available at search.ietf.org/internet-drafts/ draft-martini-12circuit-mpls-06.txt.

In accordance with the protocol proposed by Martini et al., before initiating the layer 2 service, the MPLS tunnel is established between the ingress and egress nodes. To set up the required VC label binding for the layer 2 service, the ingress node sends a signaling packet to the egress node carrying a group ID and a VC ID. The group ID represents an administrative group of VCs, and is used for administrative operations on the group. The VC ID is used by the layer 2 service endpoints to associate the locally-configured service with the tunnel. This process is unidirectional, and must be repeated in both directions for duplex communications.

An alternative approach for extending layer 2 VLANs through MPLS tunnels has been proposed by Senevirathne et al., in an IETF draft entitled “Use of CR-LDP or RSVP-TE to Extend 802.1Q Virtual LANs across MPLS Networks” (October, 2000), which is incorporated herein by reference. This document is available at search.ietf.org/internet-drafts/draft-tsenevir-8021qmpls-01.txt. The FEC element used in MPLS signaling is extended to create a VLAN FEC (or VFEC), which identifies not only the egress node, but also the VLAN mapping for Ethernet service to be provided at the egress node.

In a further IETF draft, entitled “Distribution of 802.1Q VLAN Information Using BGP 4-MP Extensions” (November, 2000), which is incorporated herein by reference, Senevirathne et al. describe an enhanced method for distributing VLAN information. This document is available at search.ietf.org/internet-drafts/draft-tsenevir-8021qbgp-00.txt. The method described in this draft is meant to enable set-up of end-to-end VLAN services through MPLS tunnels between autonomous layer 2 systems at opposite sides of the IP network. A VLAN Domain Identifier (VDI) is defined for distributing multiple, mutually-exclusive layer 2 topologies over the MPLS infrastructure. The VDI is used for binding VLAN services to MPLS tunnels, in a manner similar to the group ID and VC ID of Martini et al. The VDI provides VFEC connectivity between nodes and ports in the participating layer 2 systems. Implementing this feature, however, requires manual configuration of the VFEC to the VID in all nodes along the tunnel, as well as substantial extensions to current routing protocols.

MPLS tunnels can also be used to carry SONET (Synchronous Optical Network) frames, as described, for example, by Malis et al., in an IETF draft entitled, “SONET/SDH Circuit Emulation Service Over MPLS (CEM) Encapsulation” (April, 2001), which is incorporated herein by reference. This document is available at search.ietf.org/internet-drafts/draft-malis-sonet-ces-mpl s-04.txt. Like the Ethernet tunneling methods described above, the method described by Malis et al. still requires separate unidirectional configuration of the nodes at both ends of the tunnels that are used.

### SUMMARY OF THE INVENTION

It is an object of some aspects of the present invention to provide improved methods and systems for carrying layer 2 services through label-switched network tunnels.

In preferred embodiments of the present invention, bi-directional layer 2 service is established between users connected to respective ports of network nodes at opposite ends of a MPLS tunnel. For convenience, these nodes are referred to here as an originating node and a responding node. To facilitate establishment of the service connection, a novel service index is created, identifying the layer 2 port on which the service is to be provided, and optionally the VLAN addresses for the service, as well. The originating node creates a tunnel to the responding node (or uses an existing tunnel), and sends a signaling message to the responding node that includes the index, the conventional FEC information and service parameters of the responding nodes. The responding node uses the service index to create or identify a tunnel to the originating node, to configure the service at its own end of the connection, and to send a signaling message in return to the originating node. When the originating node receives the return message, it completes the connection and initiates the layer 2 bi-directional service.

By comparison with protocols known in the art, the signaling exchange provided by the present invention allows layer 2 service connections to be established simply and efficiently. As noted above, the service index can be used conveniently to designate both the port and the VLAN address. It can also be used to identify different types of services, such as point-to-point services and multi-user transparent LAN services (TLS) or virtual bridges. The method is also applicable to setting up of SONET paths over MPLS. Preferably, the service index is included as a standard entry in a management information base (MIB) held at both the originating and the responding nodes, and is conveyed between the nodes as an extension to a standard signaling protocol, such as RSVP-TE. In this manner, only the originating and responding nodes at the edges of the network need to be involved in establishing and providing the layer 2 service, while the nodes that provide the tunnel through the network can continue to operate using the MPLS and RSVP-TE protocols without modification.

Although preferred embodiments are described herein with reference to certain specific communication protocols, it will be appreciated that the principles of the present invention may also be applied to the provision of layer 2 (data link) services over networks and protocols of other types.

There is therefore provided, in accordance with a preferred embodiment of the present invention, a method for establishing a data link service connection for a bi-directional service to be provided between first and second nodes through a network, the method including:

responsive to a request to initiate the service connection at the first node, generating a local index at the first node indicative of the service to be provided;

sending a first signaling message containing the index from the first node and service parameters of both of the nodes via the network to the second node;

upon receiving the message at the second node, initiating the service connection at the second node responsive to the index and the service parameters, and sending a second signaling message via the network to the first node; and

upon receiving the second signaling message at the first node, activating the service indicated by the index.

Preferably, the service parameters are indicative of a data link port on which the service is to be provided on the first node and/or the second node, and wherein activating the service includes activating the service on the data link port indicated by the service parameters. Fur preferably, the service parameters are indicative of the data link port on the first node on which the service is to be provided. In a preferred embodiment, the service connection includes an Ethernet connection, and wherein the index is further indicative of a Virtual LAN (VLAN) address to which the service is to be provided.

In another preferred embodiment, the service includes a transparent LAN service (TLS), and the index is indicative of a TLS instance on which the service is to be provided.

In yet another preferred embodiment, the service includes a SONET service, and the service parameters are indicative of a SONET path on which the service is to be provided.

Preferably, the service parameters further contain a field identifying a service type of the requested service. Additionally or alternatively, the service parameters and/or the index are configured to form a part of a Management Information Base maintained at the nodes.

Preferably, sending the first signaling message includes sending a signaling packet in which the service parameters are encapsulated in an object that is ignored and passed on by routers along the route of the packets, and is received and read only at the second node. Most preferably, sending the signaling packet includes sending a resource reservation packet in which the object has a class number that causes the routers to ignore it.

There is also provided, in accordance with a preferred embodiment of the present invention, a method for establishing a data link service connection for a service to be provided between first and second nodes via a label-switched tunnel through a network, the method including:

responsive to a request to initiate the service connection at the first node, generating a local index at the first node indicative of the service to be provided;

sending a signaling packet from the first node via the network to the second node, with the index encapsulated in the signaling packet in an object that is ignored and passed on by label-switching routers along the label-switched tunnel, and is received and read only at the second node; and

initiating the service connection at the second node responsive to the index received in the signaling packet.

Preferably, sending the signaling packet includes sending a resource reservation packet in which the object has a class number that causes the label-switching routers to ignore it.

There is additionally provided, in accordance with a preferred embodiment of the present invention, a communication network, including:

first and second access nodes; and

a plurality of intermediate nodes that are configured to operate as packet-switching routers so as to convey data packets between the first and second access nodes,

wherein the access nodes are configured so that responsive to a request to initiate a data link service connection at the first node for a bi-directional service to be provided between the first and second nodes, a local index is generated at the first node indicative of the service to be provided, and a first signaling message containing the index and service parameters of both of the nodes is sent from the first node via the intermediate nodes to the second node, and so that upon receiving the first signaling message at the second node, the service connection is initiated at the second node responsive to the index and the service parameters, and a second signaling message is sent via the intermediate nodes to the first node, and so that upon receiving the second signaling message at the first node, the service indicated by the index is activated.

There is further provided, in accordance with a preferred embodiment of the present invention, a communication network, including:

first and second access nodes; and

a plurality of intermediate nodes that are configured to operate as label-switched routers so as to provide a label-switched tunnel between the first and second access nodes,

wherein the access nodes are configured so that responsive to a request to initiate the service connection at the first node, a local index is generated at the first node indicative of the service to be provided, and a signaling packet is sent from the first node via the network to the second node, with the index encapsulated in the signaling packet in an object that is ignored and passed on by label-switching routers along the tunnel, and is received and read only at the second node, and so that the service connection is initiated at the second node responsive to the index received in the signaling packet.

There is moreover provided, in accordance with a preferred embodiment of the present invention, a method for establishing a data link service connection for a bidirectional service to be provided between first and second nodes via first and second label-switched tunnels through a network, the method including:

responsive to a request to initiate the service connection at the first node, generating a local index at the first node indicative of parameters of the service to be provided;

sending a first signaling message containing the index from the first node via the network to the second node;

upon receiving the message at the second node, initiating the service connection at the second node responsive to the index, and sending a second signaling message via the network to the first node; and

upon receiving the second signaling message at the first node, activating the service indicated by the index via the first and second label-switched tunnels.

There is furthermore provided, in accordance with a preferred embodiment of the present invention, a communication network, including:

first and second access nodes; and

a plurality of intermediate nodes that are configured to operate as label-switched routers so as to provide first and second label-switched tunnels between the first and second access nodes,

wherein the access nodes are configured so that responsive to a request to initiate a data link service connection at the first node for a bidirectional service to be provided between the first and second nodes, a local index is generated at the first node indicative of parameters of the service to be provided, and a first signaling message containing the index is sent from the first node via the network to the second node, and so that upon receiving the first signaling message at the second node, the service connection is initiated at the second node responsive to the index, and a second signaling message is sent via the network to the first node, and so that upon receiving the second signaling message at the first node, the service indicated by the index is activated via the first and second label-switched tunnels.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a system for network communications, in accordance with a preferred embodiment of the present invention; and

FIGS. 2A and 2B are flow charts that schematically illustrate a method for setting up a communication service, in accordance with a preferred embodiment of the present invention.

### DETAILED DESCRIPTION OF PREFERRED EMBODIMENTS

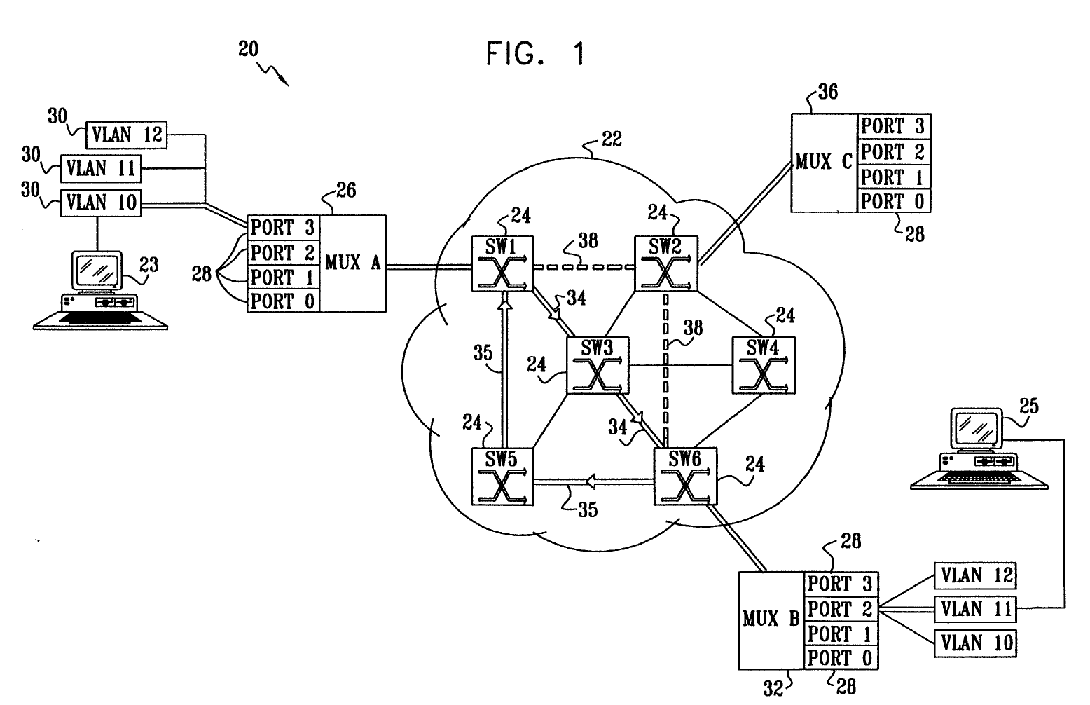

FIG. 1 is a block diagram that schematically illustrates a system 20 for providing layer 2 communication services over an IP (and/or MPLS) network 22, in accordance with a preferred embodiment of the present invention. This figure illustrates, by way of example, a point-to-point Ethernet service connection between a first user 23 and a second user 25 that is set up via MPLS tunnels 34 and 35 through network 22. User 23 is connected to network 22 by an Ethernet connection to a first access switch 26. This switch, labeled “MUX A,” typically multiplexes among multiple users, connected to different Ethernet ports 28 of the switch and having different VLAN addresses 30. In the present example, user 23 is connected to PORT3 of switch 26 on VLAN10. User 25 is connected to network 22 through Ethernet PORT2 of another access switch 32, labeled “MUX B,” on VLAN11. The layer 2 traffic between users 23 and 25 is encapsulated and labeled for MPLS transmission by switches 26 and 32. The labeled packets are passed by LSR switches 24 from switch 26 to switch 32 through tunnel 34, and from switch 32 to switch 26 through tunnel 35, as is known in the art.

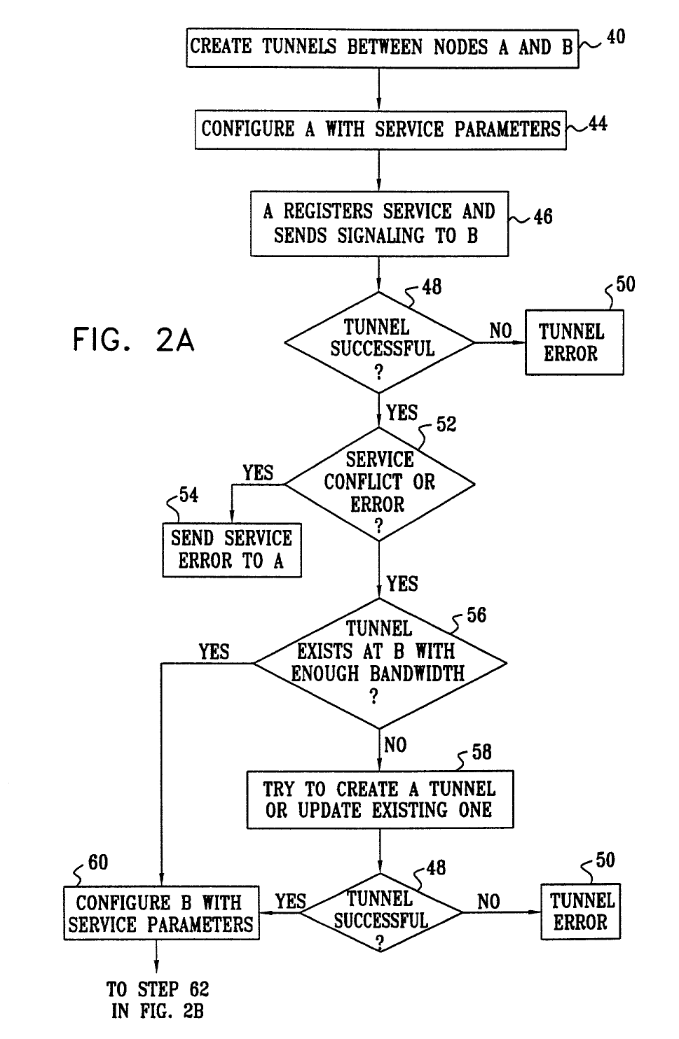

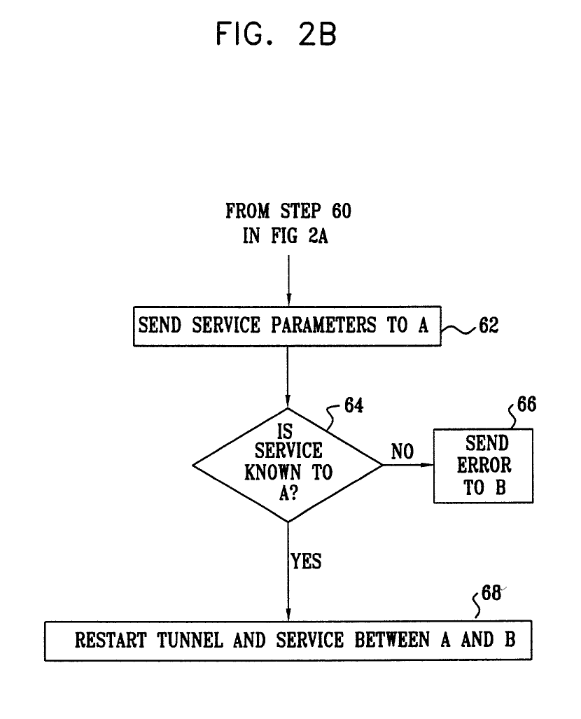

FIGS. 2A and 2B are flow charts that schematically illustrate a method for setting up the Ethernet service between users 23 and 25, in accordance with a preferred embodiment of the present invention. For the sake of the present example, the service is identified as a virtual connection (VC), with a group ID and a VC ID, in accordance with the scheme proposed by Martini et al. Alternatively, the service could be identified using a VLAN Domain Identifier (VDI), as proposed by Senevirathne et al., or using other, equivalent identification schemes without substantially altering the method described below. It is assumed that tunnels 34 and 35 are created in advance between switches 26 and 32 at a tunnel creation step 40. (These switches are respectively referred to generically as “Node A” and “Node B” in the flow charts.) The tunnels are created after setting parameters that include a traffic descriptor, a profile for COS (class of service) marking, enable/disable of policing, a pointer to the tunnel creation parameters (such as whether or not the tunnel is explicitly routed—i.e., assigned a predetermined path through the network—using RSVP-TE), and the IP address of the destination switch. Alternatively, only tunnel 34 need be created initially, and tunnel 35 can be set up in response to the request sent from switch 26 to switch 32 to set up the Ethernet service. Tunnels 34 and 35 may pass through the same LSRs 24 or through different LSRs, as shown in the figure, as is known in the MPLS art.

Next, switch 26 is configured with parameters of the service that is to be provided, at a service configuration step 44. These parameters include the physical port and VLAN for the service on switch 26, the VC encapsulation scheme to be used (with or without VLAN information), traffic descriptors for the Ethernet service, the interface parameters at switch 32 and the tunnel ID of tunnel 34. The Ethernet traffic descriptors preferably include descriptors for both the direction from switch 26 to switch 32 and the direction from switch 32 to switch 26, which indicate the bandwidth required in each direction and the class of service (i.e., priority). The service is assigned its group ID and VC ID.

Switch 26 now registers the requested service in a service table that it maintains and sends a signaling message regarding the service to switch 32, at a signaling step 46. Preferably, the service is registered in a local database at the switch. The registration information typically includes a logical index to a physical port to be used by the service, such as the IfIndex used in the standard MIB (Management Information Base), as is known in the art. Most preferably, the signaling message sent from switch 26 to switch 32 contains both the IfIndex for the service on switch 32 and the IfIndex for the service on switch 26 (although the latter is optional). The IfIndex of the service on switch 26 is used by switch 32 in initiating return service to switch 26 over tunnel 35, as described below. The message preferably includes a type field, indicating to switch 32 the type of service: point-to-point, TLS, SONET over MPLS, etc. An additional index is typically added to the signaling message to specify the range of VLANs for Ethernet services, or the number of the SONET path for SONET signals at both ends of the connection.

The signaling message from switch 26 is preferably conveyed through tunnel 34 using RSVP-TE, although other protocols may also be used. For this purpose, a new RSVP-TE object is defined to carry the IfIndex between switches 26 and 32. As an example of a possible implementation, this object typically comprises a 32-bit data field for the IfIndex, and is assigned to RSVP Interface Notify Class 200 and C-Type 13, as specified in the above-mentioned RFC 2205, section 3.10. Because the first two bits in the class number have the value “1”, switches 24 will ignore this object and will simply forward it, unexamined and unmodified. Switches 26 and 32, of course, are programmed to read and use the object. Alternative implementations will be apparent to those skilled in the art.

Preferably, when the Ethernet service is to be set up between users on respective VLANs (as in the present example), the RSVP-TE Interface Notify Object carrying the IfIndex is extended by addition of a VLAN object. This object notifies the receiving switch of the range of VLAN values to which the data frames flowing in this LSP tunnel are to be delivered, via the port specified by the IfIndex object. Continuing with the example described above, the Interface Notify Object is assigned to RSVP Interface Notify Class 201 and C-Type 10 and contains two fields: a Lower VLAN Value (LVV) and a Higher VLAN Value (HVV), both 16 bits (although for VLAN applications, only 12 bits are actually required). These values respectively represent the lower and upper values of the VLAN value range of the tunneled data that should be delivered on the port specified by the IfIndex. They are needed particularly for handling cases in which the VLAN values used at switch 32 are different from those used at switch 26. (Otherwise, switch 32 does not need to know explicitly the VLAN at switch 26, and the tunnel in this case can carry a null VLAN value). The VLAN values are carried for consistency in all cases, however, and enable switch 32 to check received packets in order to ensure that the expected VLAN was used. If more than one range of VLAN values are to be delivered on the outgoing port of the switch, an additional service instance is required (with a different VC ID).

Preferably, for each type of field, the VLAN object interpretation is as follows:

1. Service Type=one VLAN. When the packet should be delivered only to a specific VLAN field value, the VLAN object will have the values LVV=VLAN in switch 26, and HVV=VLAN in switch 32. Typically, LVV=HVV. VLL and/or HVV can be zero. If a value of 1024 (illegal value as VLAN tag) is used in one or more fields, the packet should be received from or transmitted to this interface without VLAN tag.

2. Service Type=range. LVV<HVV. All VLANs between VLAN=LVV and VLAN=HVV are mapped to the service at both ends of the connection.

3. Service Type=transparent. Any incoming VLAN value will be considered valid, and the packet carrying it will be delivered to the outgoing port specified by IfIndex if LVV=HVV=65535 (all ones).

In the case of SONET service, a similar PATH object may be used, in place of the VLAN object. In this case, the first field of the object is used to identify the path number in the interface at switch 26, and the second field to identify the path number in the interface at switch 32. Alternatively, the interface indices in the signaling message may directly designate the path.

TLS can be distinguished from point-to-point service either as a special index in the VC type field in standard Layer 2 signaling, as a special group ID, or by adding types to the service types above.

Returning now to FIG. 2A, the signaling sent from switch 26 to switch 32 may fail if tunnel 34 cannot be created or does not successfully convey the signaling packet to switch 32, at a tunnel failure step 48. In the event of such a failure, the unidirectional service registration is deleted from the UDSNC (Uni-Directional Service Network Connection) table maintained in the local database at switch 26, and an error notification is sent to the operator, at an error reporting step 50. If the signaling message passed successfully, switch 32 checks its own service database to determine whether it is already configured for this service, as indicated by the VC ID and VC type of the message, at a service consistency checking step 52. If there is no current service defined for this VC ID and VC type, the switch checks whether an existing service will interfere with the requested service for the specified IfIndex. For example, the switch preferably checks whether there is overlap in VLAN range with existing services on the same port, and whether the IfIndex is of the correct type. If such a conflict exists or the service is already defined, the service cannot be initiated and a “service error” notification is sent to switch 26, at a service error step 54. The switch in turn informs the operator of the error situation.

Based on the information in the signaling packet received from switch 26, switch 32 checks whether there is already a tunnel in existence from switch 32 to switch 26 with sufficient bandwidth for the service, at a tunnel checking step 56. If tunnel 35 already exists (by manual pre-configuration, for example), the signaling message from switch 26 may contain the tunnel ID of tunnel 35. In this case, switch 32 goes directly to a return service configuration step 60, which is described below. Otherwise, switch 32 may generate the tunnel automatically or try to update an existing tunnel with extended bandwidth, at a tunnel update step 58, if it is configured to do so based on the required parameters that are present in the incoming signaling. If the tunnel signaling fails, the node reports the failure (at repeat instances of steps 48 and 50), and the service creation is stopped.

Once switch 32 has found a satisfactory existing tunnel or successfully created a new one, it goes on to step 60. At this step, switch 32 is configured with the required service parameters for the return path. These parameters include a traffic descriptor for the service, a profile for COS marking, enable/disable of policing, and the IP address of switch 26. The parameters also include the physical port and VLAN for the service on switch 32, the VC encapsulation scheme and the tunnel ID. The unidirectional service thus established from switch 32 to switch 26 is assigned the same VC ID and the same VC type as have been configured for the connection at switch 26.

Switch 32 registers the service thus established in its own service table and sends a signaling message back to switch 26, at a return messaging step 62. Assuming the signaling message reaches switch 26, switch 26 checks its service database for the VC ID and VC type specified by the message, at a return service ID checking step 64. If for some reason switch 26 does not recognize these parameters, it sends a failure message to switch 32, at a return service error step 66.

Normally, however, switch 26 will recognize the VC ID and VC type as the same ones that it originally sent to switch 32. In response, switch 26 restarts the unidirectional service that was set up pending the completion of the service on both directions, at a restart step 68. At the same time, switch 26 sends a signaling message back to switch 32, confirming that it is prepared to receive the unidirectional service from switch 32 via tunnel 35. Both switches 26 and 32 can now activate the bi-directional Ethernet connection between users 23 and 25 on the specified ports and VLAN addresses.

Although the example described above relates to creation of a point-to-point service, a similar protocol can be used to set up other service configurations, such as virtual bridges (TLS). FIG. 1 shows an example of such a service, wherein additional tunnels 38 connect switches 26 and 32 to a further switch 36. Users connected to ports 28 of switches 26, 32 and 36 are able to send and receive layer 2 packets, such as Ethernet frames, to other users connected to the other switches, as though all of the users were together located on a single LAN. In this case, a TLS instance indicator is preferably added to the port/VLAN index carried by the signaling packets to indicate the particular virtual bridge that is to be used. Preferably, the IfIndex parameter is used as described above to indicate the port for the service. Alternatively, a general service ID may be used.

Although preferred embodiments are described herein with reference to certain specific communication protocols, such as Ethernet and SONET, it will be appreciated that the principles of the present invention may also be applied to the provision of tunneled layer 2 (data link) services over networks and protocols of other types. In particular, these methods described hereinabove may be used to establish ATM and Frame Relay service connections, inter alia. These methods can also be used, mutatis mutandis, in conjunction with other network tunneling schemes, as are known in the art. They are useful generally in establishing bi-directional packet-switched network service connections, even when these connections do not make explicit use of tunnels.

It will be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for establishing a data link service connection for a bi-directional service to be provided between first and second nodes through a network, the method comprising:
responsive to a request to initiate the service connection at the first node, generating a local index at the first node indicative of the service to be provided;
sending a first signaling message containing the index from the first node and service parameters of both of the nodes via the network to the second node;
upon receiving the message at the second node, initiating the service connection at the second node responsive to the index and the service parameters, and sending a second signaling message via the network to the first node; and
upon receiving the second signaling message at the first node, activating the service indicated by the index.

2. A method according to claim 1, wherein the service parameters are indicative of a data link port on which the service is to be provided, and wherein activating the service comprises activating the service on the data link port indicated by the service parameters.

3. A method according to claim 2, wherein the service parameters are indicative of the data link port on the first node on which the service is to be provided.

4. A method according to claim 2, wherein the service parameters are indicative of the data link port on the second node on which the service is to be provided.

5. A method according to claim 2, wherein the service connection comprises an Ethernet connection, and wherein the index is further indicative of a Virtual LAN (VLAN) address to which the service is to be provided.

6. A method according to claim 1, wherein the service comprises a transparent LAN service (TLS), and wherein the index is indicative of a TLS instance on which the service is to be provided.

7. A method according to claim 1, wherein the service comprises a SONET service, and wherein the service parameters are indicative of a SONET path on which the service is to be provided.

8. A method according to claim 1, wherein the service parameters further contain a field identifying a service type of the requested service.

9. A method according to claim 1, wherein the service parameters are configured to form a part of a Management Information Base maintained at the nodes.

10. A method according to claim 1, wherein sending the first signaling message comprises sending a signaling packet in which the service parameters are encapsulated in an object that is ignored and passed on by packet-switching routers along a route of the packet, and is received and read only at the second node.

11. A method according to claim 10, wherein sending the signaling packet comprises sending a resource reservation packet in which the object has a class number that causes the routers to ignore it.

12. A method for establishing a data link service connection for a service to be provided between first and second nodes via a label-switched tunnel through a network, the method comprising:
responsive to a request to initiate the service connection at the first node, generating a local index at the first node indicative of the service to be provided;
sending a signaling packet from the first node via the network to the second node, with the index encapsulated in the signaling packet in an object that is ignored and passed on by label-switching routers along the label-switched tunnel, and is received and read only at the second node; and
initiating the service connection at the second node responsive to the index received in the signaling packet.

13. A method according to claim 12, wherein sending the signaling packet comprises sending a resource reservation packet in which the object has a class number that causes the label-switching routers to ignore it.

14. A communication network, comprising:
first and second access nodes; and
a plurality of intermediate nodes that are configured to operate as packet-switching routers so as to convey data packets between the first and second access nodes,
wherein the access nodes are configured so that responsive to a request to initiate a data link service connection at the first node for a bi-directional service to be provided between the first and second nodes, a local index is generated at the first node indicative of the service to be provided, and a first signaling message containing the index and service parameters of both of the nodes is sent from the first node via the intermediate nodes to the second node, and so that upon receiving the first signaling message at the second node, the service connection is initiated at the second node responsive to the index and the service parameters, and a second signaling message is sent via the intermediate nodes to the first node, and so that upon receiving the second signaling message at the first node, the service indicated by the index is activated.

15. A network according to claim 14, wherein the service parameters are indicative of a data link port on which the service is to be provided, and wherein the service is activated on the data link port indicated by the service parameters.

16. A network according to claim 15, wherein the service parameters are indicative of the data link port on the first node on which the service is to be provided.

17. A network according to claim 15, wherein the service parameters are indicative of the data link port on the second node on which the service is to be provided.

18. A network according to claim 15, wherein the service connection comprises an Ethernet connection, and wherein the service parameters are further indicative of a Virtual LAN (VLAN) address to which the service is to be provided.

19. A network according to claim 14, wherein the service comprises a transparent LAN service (TLS), and wherein the service parameters are indicative of a TLS instance on which the service is to be provided.

20. A network according to claim 14, wherein the service comprises a SONET service, and wherein the service parameters are indicative of a SONET path on which the service is to be provided.

21. A network according to claim 14, wherein the service parameters further contain a field identifying a service type of the requested service.

22. A network according to claim 14, wherein the service parameters are configured to form a part of a Management Information Base maintained at the nodes.

23. A network according to claim 14, wherein the first signaling message comprises a signaling packet in which the service parameters are encapsulated in an object that is ignored and passed on by the intermediate nodes along a route of the packet, and is received and read only at the second node.

24. A network according to claim 23, wherein the signaling packet comprises a resource reservation packet in which the object has a class number that causes the label-switching routers to ignore it.

25. A communication network, comprising:
first and second access nodes; and
a plurality of intermediate nodes that are configured to operate as label-switched routers so as to provide a label-switched tunnel between the first and second access nodes,
wherein the access nodes are configured so that responsive to a request to initiate the service connection at the first node, a local index is generated at the first node indicative of the service to be provided, and a signaling packet is sent from the first node via the network to the second node, with the index encapsulated in the signaling packet in an object that is ignored and passed on by label-switching routers along the tunnel, and is received and read only at the second node, and so that the service connection is initiated at the second node responsive to the index received in the signaling packet.

26. A network according to claim 25, wherein the signaling packet comprises a resource reservation packet in which the object has a class number that causes the label-switching routers to ignore it.

27. A method for establishing a data link service connection for a bidirectional service to be provided between first and second nodes via first and second label-switched tunnels through a network, the method comprising:
responsive to a request to initiate the service connection at the first node, generating a local index at the first node indicative of parameters of the service to be provided;
sending a first signaling message containing the index from the first node via the network to the second node;
upon receiving the message at the second node, initiating the service connection at the second node responsive to the index, and sending a second signaling message via the network to the first node; and
upon receiving the second signaling message at the first node, activating the service indicated by the index via the first and second label-switched tunnels.

28. A method according to claim 27, wherein the index is indicative of a data link port on which the service is to be provided, and wherein activating the service comprises activating the service on the data link port indicated by the index.

29. A method according to claim 28, wherein the index is indicative of the data link port on the first node on which the service is to be provided.

30. A method according to claim 28, wherein the index is indicative of the data link port on the second node on which the service is to be provided.

31. A method according to claim 28, wherein the service connection comprises an Ethernet connection, and wherein the index is further indicative of a Virtual LAN (VLAN) address to which the service is to be provided.

32. A method according to claim 27, wherein the service comprises a transparent LAN service (TLS), and wherein the index is indicative of a TLS instance on which the service is to be provided.

33. A method according to claim 27, wherein the service comprises a SONET service, and wherein the index is indicative of a SONET path on which the service is to be provided.

34. A method according to claim 27, wherein the index further contains a field identifying a service type of the requested service.

35. A method according to claim 27, wherein the index is configured to form a part of a Management Information Base maintained at the nodes.

36. A method according to claim 27, wherein sending the first signaling message comprises sending a signaling packet in which the index is encapsulated in an object that is ignored and passed on by label-switching routers along the tunnel, and is received and read only at the second node.

37. A method according to claim 36, wherein sending the signaling packet comprises sending a resource reservation packet in which the object has a class number that causes the label-switching routers to ignore it.

38. A communication network, comprising:
first and second access nodes; and
a plurality of intermediate nodes that are configured to operate as label-switched routers so as to provide first and second label-switched tunnels between the first and second access nodes,
wherein the access nodes are configured so that responsive to a request to initiate a data link service connection at the first node for a bidirectional service to be provided between the first and second nodes, a local index is generated at the first node indicative of parameters of the service to be provided, and a first signaling message containing the index is sent from the first node via the network to the second node, and so that upon receiving the first signaling message at the second node, the service connection is initiated at the second node responsive to the index, and a second signaling message is sent via the network to the first node, and so that upon receiving the second signaling message at the first node, the service indicated by the index is activated via the first and second label-switched tunnels.

39. A network according to claim 38, wherein the index is indicative of a data link port on which the service is to be provided, and wherein the service is activated on the data link port indicated by the index.

40. A network according to claim 39, wherein the index is indicative of the data link port on the first node on which the service is to be provided.

41. A network according to claim 39, wherein the index is indicative of the data link port on the second node on which the service is to be provided.

42. A network according to claim 39, wherein the service connection comprises an Ethernet connection, and wherein the index is further indicative of a Virtual LAN (VLAN) address to which the service is to be provided.

43. A network according to claim 38, wherein the service comprises a transparent LAN service (TLS), and wherein the index is indicative of a TLS instance on which the service is to be provided.

44. A network according to claim 38, wherein the service comprises a SONET service, and wherein the index is indicative of a SONET path on which the service is to be provided.

45. A network according to claim 38, wherein the index further contains a field identifying a service type of the requested service.

46. A network according to claim 38, wherein the index is configured to form a part of a Management Information Base maintained at the nodes.

47. A network according to claim 38, wherein the first signaling message comprises a signaling packet in which the index is encapsulated in an object that is ignored and passed on by the label-switched routers along the tunnel, and is received and read only at the second node.

48. A network according to claim 47, wherein the signaling packet comprises a resource reservation packet in which the object has a class number that causes the label-switched routers to ignore it.
